(19) United States
(12) Patent Application Publication
(10) Pub. No.: US 2017/0039993 A1
(43) Pub. Date: Feb. 9, 2017

(54) Optimized Screen Brightness Control Via Display Recognition From a Secondary Device

(71) Applicant: International Business Machines Corporation, Armonk, NY (US)

(72) Inventors: Rahul Ghosh, Morrisville, NC (US); William R. LaRiccia, Durham, NC (US); Ravi K. Muthukrishnan, Bangalore (IN); Aaron J. Quirk, Durham, NC (US); Xian Jun Zhu, Shanghai (CN)

(73) Assignee: International Business Machines Coprporation, Armonk, NY (US)

(21) Appl. No.: 14/817,321

(22) Filed: Aug. 4, 2015

(51) Int. Cl. G09G 5/10

(52) U.S. Cl. CPC G09G 5/10; G09G 2370/04; G09G 2360/144; G09G 2320/0233

(57) ABSTRACT

Provided are techniques for displaying a first image on a first device, wherein the first image comprises an image characteristic; analyzing, at a second device remote from the first device, a viewing characteristic corresponding to the first image; responsive to detecting the viewing characteristic meets a criteria, transmitting a signal from the second device to the first device; and responsive to the signal, controlling a programmable parameter corresponding to the image characteristic on the first device to modify a display of a second image on the first device.

### FIELD OF DISCLOSURE

The claimed subject matter relates generally to mobile display devices and, more specifically, to techniques for controlling brightness on a mobile device based upon a measurement from a secondary device.

### BACKGROUND OF THE INVENTION

Dynamic brightness control on a mobile device screen is a commonly provided feature, A screen backlight is a primary consumer of battery power and, therefore, it is important for the backlight to be as dim as possible to conserve energy. However, the backlight strength must be balanced with a user's need to clearly see the content on the screen. One current approach to dynamic brightness control issues is to use an ambient light sensor on the mobile device to detect a current intensity of ambient light, and adjust the screen backlight as a function of the intensity.

However, this approach is not always ideal. For example, a mobile device may be located in a low-intensity area while the user's lace or eyes may be in a high-intensity area. In this situation, the mobile device is in a shadow and the user's eyes are in direct sunlight and may be receiving a lot of glare. An ambient light data point based upon the current intensity at the mobile device would typically cause the screen to be too dim for the user to view effectively.

### SUMMARY

Provided are techniques for controlling display attributes on a mobile, or “primary,” device based upon measured parameters at a secondary device. A secondary device (e.g. watch or glasses) may dynamically use a camera to recognize the. screen of the primary device. The relative brightness of the primary device's screen from perspective of the secondary device may be calculated and used as additional data point to adjust the primary device's display intensity. Other display parameters such as, but not limited to, image or font size, may also be similarly controlled.

Areas of novelty may include, but are not limited to, recognizing the screen of a primary device using the camera of a secondary device; calculating the relative light intensity of a primary device from perspective of secondary device; comparing pictures Or videos to estimate optimum brightness control based taking into account; and improving a real-time estimation of brightness by taking into account how the actual screen is perceived by the device closer to user eyes.

Some value added to existing devices by the disclosed technology include, but are not limited to, enabling more aggressive, more precise use of dynamic brightness control; saving battery life on mobile devices with limited capacity; and optimizing user experience

Parameters other than screen brightness may also be controlled based upon measurements at a secondary device. For example the font size of a displayed document may be adjusted based upon the distance between the primary and secondary devices.

Provided are techniques for displaying a first image on a first device, wherein the first image comprises an image characteristic; analyzing, at a second device remote from the first device, a viewing characteristic corresponding to the first image; responsive to detecting the viewing characteristic meets a criteria, transmitting a signal from the second device to the first device; and responsive to the signal, controlling a programmable parameter corresponding to the image characteristic on the first device to modify a display of a second image on the first device.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the at upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures.

FIG. 1 is an illustration of a primary and secondary device configure in accordance with the disclosed technology.

FIG. 2 is a block diagram of a Primary Device Display Control (PDDC) device that may implement aspects of the claimed subject matter.

FIG. 3 is a block diagram of a Secondary Device Data Capture (SDDC) device that may implement aspects of the claimed subject matter.

FIG. 4 is a flowchart of one example of a SDDC process that may implement aspects of claimed subject matter.

FIG. 5 is a flowchart of one example of a PDDC process that may implement aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code air carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely or partly an any of a user's multiple devices.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a suitably configured device or other programmable data processing apparatus to produce a machine, such that the instructions, which execute via one or more processors of the device or other programmable data processing apparatus, create means for implementing the functions/acts specified in the flowchart and/or block diagram block or blocks.

These computer program instructions may also be stored in a computer readable medium that can direct a device or other programmable data processing apparatus to function in a particular manner, such that the instructions stored in the computer readable medium produce an article of manufacture including instructions which implement the function/act specified in the flowchart and/or block diagram block or blocks.

The computer program instructions may also be loaded onto a device of other programmable data processing apparatus to cause a series of operational actions to be performed on the device or other programmable apparatus to produce a computer implemented process such that the instructions which execute on the computer or other programmable apparatus provide processes for implementing the functions/acts specified in the flowchart and/or block diagram block or blocks.

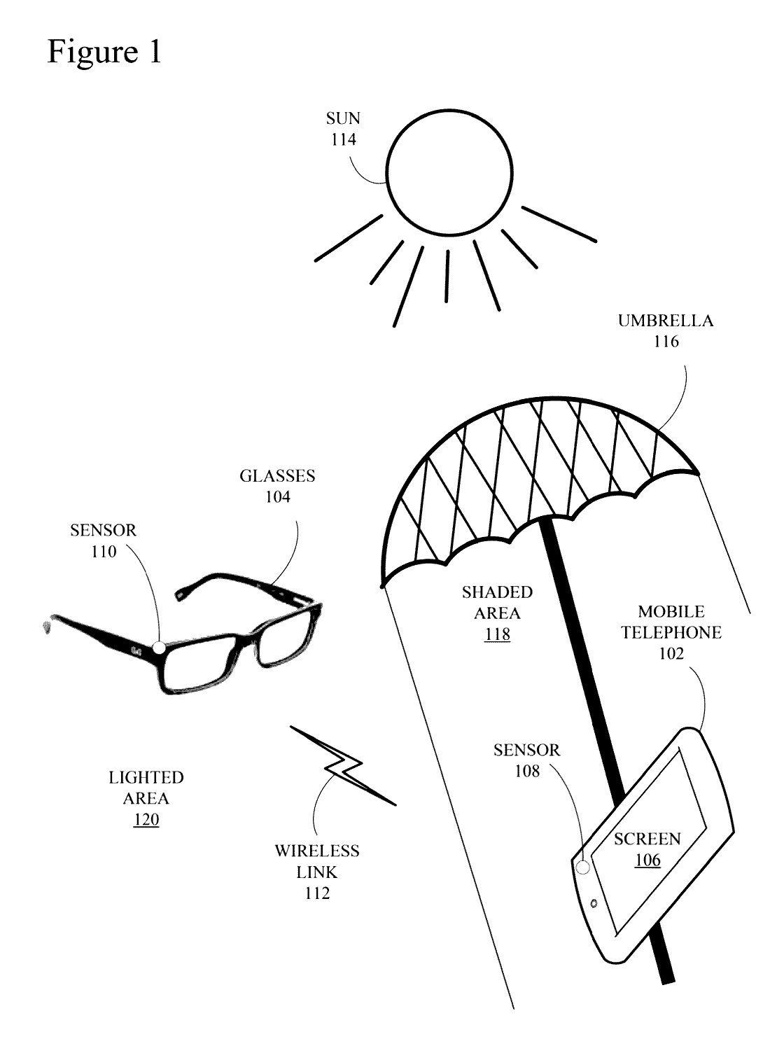

FIG. 1 is an illustration of a primary device 102, which in this example is a mobile telephone, and a secondary device 104, which in this example is a pair of glasses, configured in accordance with the disclosed technology. It should be understood that devices 102 and 104 are merely two examples throughout the Specification of the types of devices that may implement the disclosed technology. Those with skill in the relevant arts will appreciate that may other types of devices may be configured as either primary or secondary devices to take advantage of the claimed subject matter.

Mobile telephone 102 includes a display, or screen, 106 and a sensor 108. Screen 106 displays information for the operation of mobile telephone 192. Sensor 108 detects and measures environmental conditions associated with mobile telephone 102, which in this example is ambient lighting. Glasses 104 include a sensor 110, which detects and measures environmental conditions associated with glasses 104, which in this example is also ambient lighting. In alternative embodiments, sensor 110 captures an image displayed on display 106 for analysis, detects a distance between devices 102 and 104 or some combination of an image, ambient conditions and distance. Although not illustrated for the sake of simplicity, glasses 194 would typically be worn by a user employing mobile telephone 102 and viewing screen 106. A wireless link 112 provides communication between mobile telephone 102 and glasses 104. Wireless link may be, but is not limited to, Bluetooth, NFC and Wi-Fi technologies. In addition, a link between devices 102 and 104 for implementing the claimed subject matter may be a direct wired link.

In FIG. 1, ambient lighting is provided by the sun 114 and affected by an umbrella 116. Umbrella 116 partially blocks sun 114 to produce a shaded area 118. Portions of the illustrated environment that are not blocked by umbrella 116 are labeled as lighted area 120. In this example, mobile telephone 102 is positioned in shaded area 118, glasses 104 are positioned in lighted area 120 and shaded area 118 has less ambient light than lighted area 120.

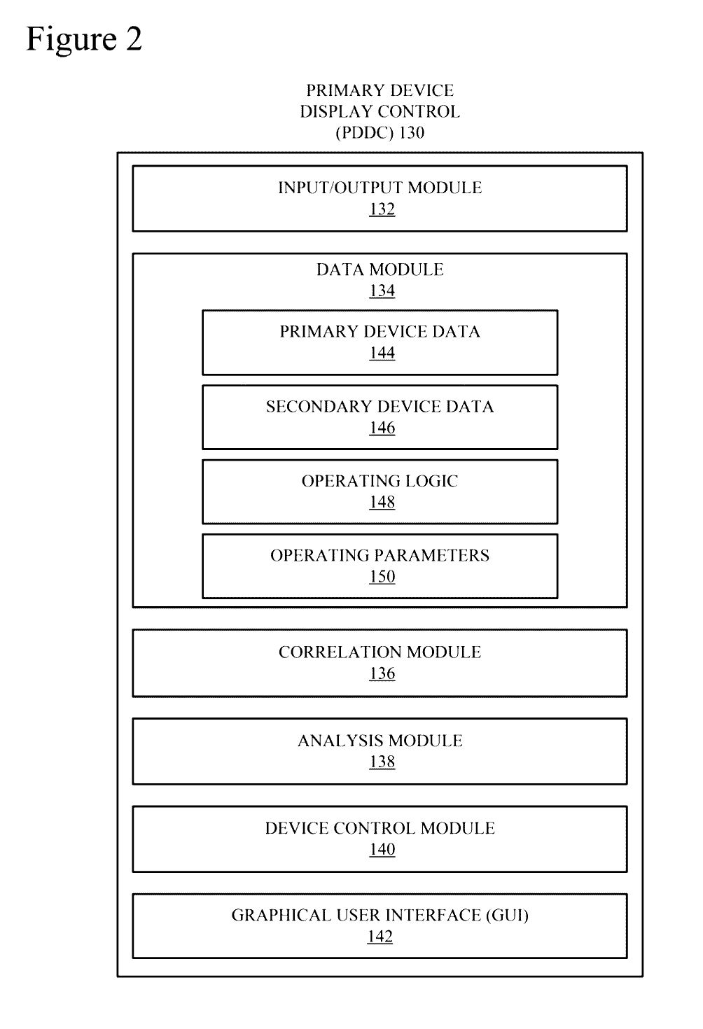

It should be understood that a typical mobile telephone would adjust backlighting of a corresponding display solely on the basis of a the ambient lighting at an associated sensor. The claimed subject matter provides control of display 106 based on environmental conditions, such as ambient light and distance between devices, with respect to both mobile telephone 102 and glasses 104. Control of a display such as display 106, based upon conditions at both primary and secondary devices, is described in detail below in conjunction with FIGS. 2-5. In addition, it should be understood that the illustrated elements of FIG. 1 are not drawn to scale.

FIG. 2 is a block diagram of a Primary Device Display Control (PDDC) module 130 that may implement aspects of the claimed subject matter. In this example, logic associated with PDDC 130 is stored in a memory (not shown) and executed on one or More processors (not shown) associated with mobile telephone 102 (FIG. 1).

PDDC 130 includes an input/output (I/O) module 132, a data module 134, a correlation module 136, an analysis module 138, a device control module 140 and a graphical user interface module, or simply “GUI,” 142. It should be understood that the claimed subject matter can be implemented in many types of devices but, for the sake of simplicity, is described only in terms of mobile telephone 102 and glasses 104 (FIG. 1). Further, the representation of PDDC 130 in FIG. 2 is a logical model. In other words, components 132, 134, 136, 138, 140 and 142 may be stored in the same or separates files and loaded and/or executed within elements of mobile telephone 102 either as a single system or as separate processes interacting via any available inter process communication (IPC) techniques.

I/O module 132 handles any communication PDDC 130 has with other components of mobile telephone 102 and glasses 104. Data module 134 is a data repository for information, including information on other devices, that PDDC 130 requires during normal operation. Examples of the types of information stored in data module 134 include primary device data 144, secondary device data 146, operating logic 148 and operating parameters 150.

Primary device data 144 stores information about the primary device, which in this example is mobile telephone 102, such as, but not limited to, information specifying access to control operations and parameters. Secondary device data 146 stores information on potential secondary devices that may be paired with mobile telephone 102 to implement the claimed subject matter. Such information may include, but is not limited to, communication protocols and parameter values and formats.

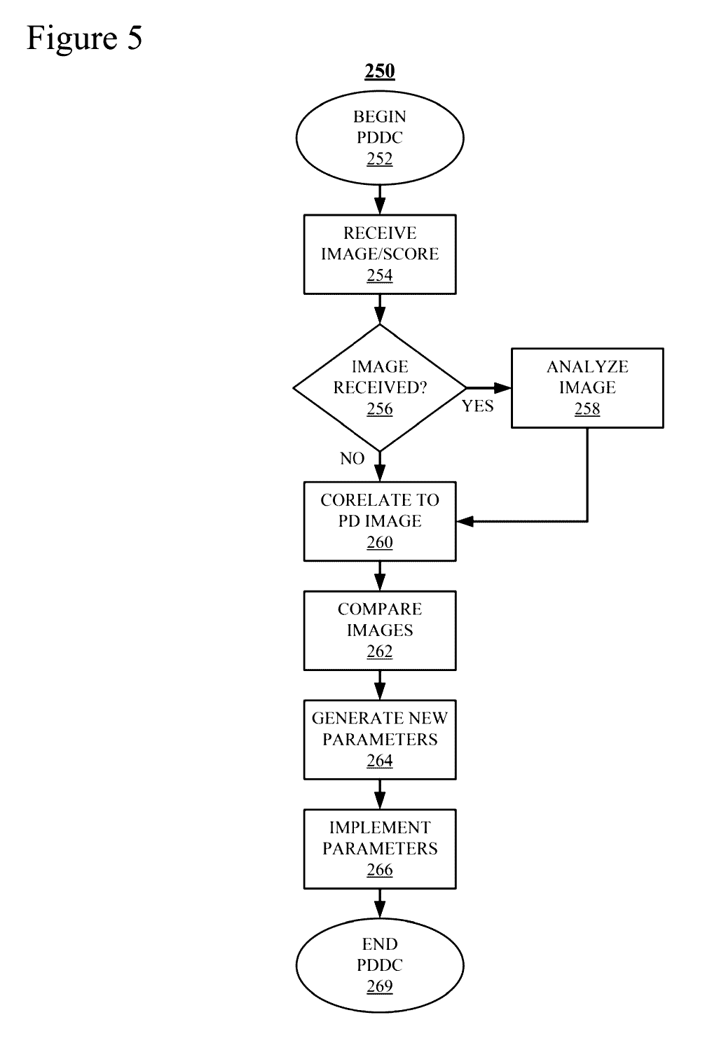

Operating logic stores executable code that is executed on one or more processors (not shown) to implement aspects of the claimed subject matter (see 250, FIG. 5). in short, executable code in operating logic coordinates processing associated with modules 132, 136, 138, 140 and 142. Operating parameters 150 stores information on various user preferences and control options that have been set.

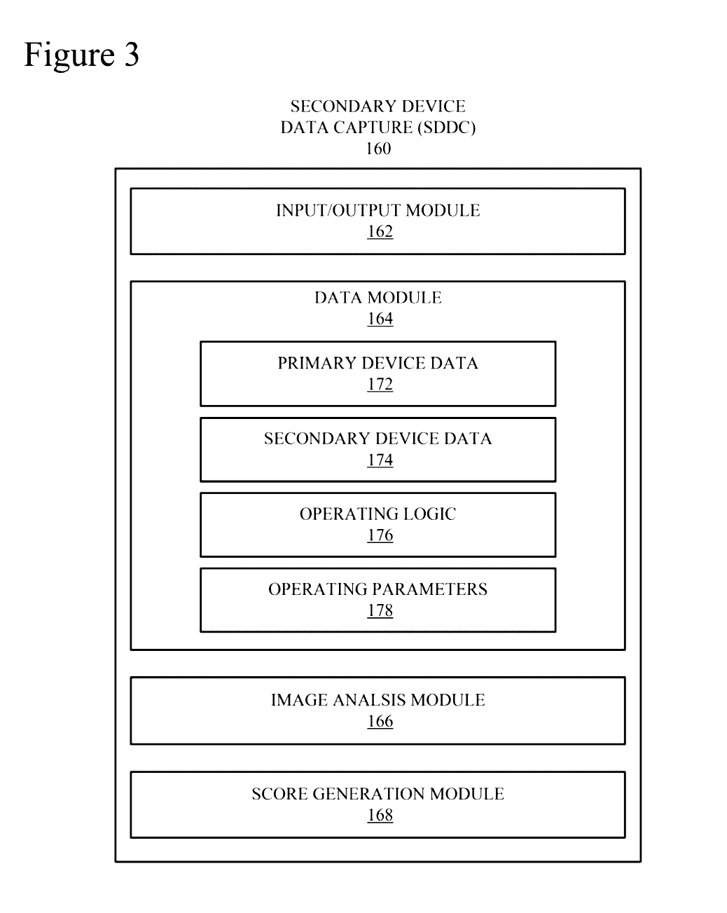

Logic associated with correlation module 136 processes data transmitted from glasses 194 and correlate the data with images displayed on display 106 (FIG. 1) of mobile telephone 102. Analysis module 138 analyzes either images or data, depending upon the particular configuration, from glasses 104 to determine parameters, such as brightness and distance, or some combination of parameters. Data from glasses 104 is then compared to corresponding data from a correlated image. Device control module 140 employs the analysis by module 138 to control screen 106. Components 132,134, 136, 138, 149, 142, 144, 146, 148 and 150 are described in more detail below in conjunction with FIGS. 3-5.

GUI 142 enables users of mobile telephone 102 to interact with and to define the desired functionality of PDDC 130 and the claimed subject matter. Typically, such functionality is controlled by the setting of variables in operating parameters 150.

It should be understood that PDDC 130 of FIG. 2 is merely one example of an appropriate configuration for implementing the claimed subject matter. Further, the representation of PDDC 130 is a logical model. In other words, components 132, 134, 136, 138, 140, 142, 144, 146, 148 and 150 may be stored in the same or separates files and loaded and/or executed within elements of mobile telephone 102 either as a single system or as separate processes interacting via any available inter process communication (IPC) techniques. PDDC 130 is described in more detail below in conjunction with FIG. 5.

FIG. 3 is a block diagram of a Secondary Device Data Capture (SDDC) module 160 that may implement aspects of the claimed subject matter. In this example, SDDC 160 is associated with logic stored in a memory and executed on a plurality of processors associated with glasses 194 (FIG. 1). It should be understood, that both PDDC 130 and SDDC 160 are both described with respect to potential functionality. In other words, some functionality described with respect to SDDC 160 may be incorporated into PDDC 130 and vice versa. Further, in the examples of FIGS. 2 and 3, some functionality may be unnecessarily duplicated to describe more of the possible configurations of the claimed subject matter.

SDDC 160 includes an input/output (I/O) module 162, a data module 164, an image analysis module 166 and a score generation module 168. I/O module 162 handles any communication SDDC 160 has with other components such as sensor 110 (FIG. 1) and PDDC 130 (FIG. 1) on mobile telephone 102 (FIG. 1). Data module 164 is a data repository for information, including information on other devices, that SDDC 160 requires during normal operation. Examples of the types of information stored in data module 162 include primary device data 172, secondary device data 174, operating logic 176 and operating parameters 178.

Primary device data 172 stores information about potential primary devices, such as mobile telephone 102, that may be paired with glasses 104. Such information may include, but is not limited to, information specifying access to control operations, communication protocols and parameters and display parameters on mobile telephone 102. Secondary device data 174 stores information on glasses 104 may include, but is not limited to, communication protocols and parameter values and formats.

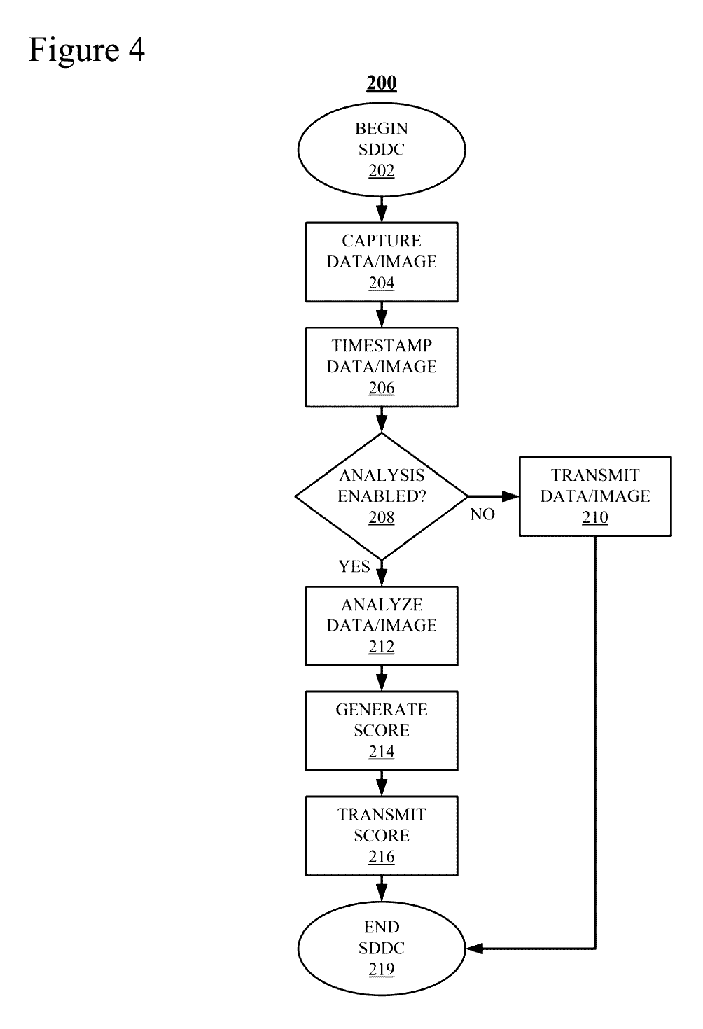

Operating logic 176 is executable code that is executed on one or more processors (not shown) to implement aspects of the claimed subject matter (see 200, FIG. 4). In short, executable code in operating logic 176 coordinates processing associated with modules 162, 166 and 168. Operating parameters 178 stores information on various user preferences and control options that have been set.

Logic associated with data capture module 166 processes signals from sensor 110 to analyze images. In the alternative, rather than analyzing images, image analysis module 166 may merely capture parameters such as ambient light readings and calculations of the distance between glasses 104 and mobile telephone 102. Logic associated with score generation module 168 processes either the images or data, depending upon the configuration, captured by data capture module 166 and sensor 110 to generate one or more “scores.” Generated scores are then transmitted to PDDC 130 for further processing. Timestamps may also be generated and transmitted to PDDC 130 in conjunction with either images or scores, depending upon the configuration, so that PDDC 130 may correlate data from SDDC 160 with specific images on PDDC 130. As explained above, in an alternative embodiment, images may not be analyzed by SDDC 160 to produce scores but rather the images would simply be transmitted to PDDC 130 on mobile telephone 102 for analysis (see 138, FIG. 2).

It should be understood that SDDC 160 of FIG. 3 is merely one example of an appropriate configuration for implementing the claimed subject matter. Further, the representation of SDDC 160 is a logical model. In other words, components 162, 164, 166, 168, 172, 174, 176 and 178 may be stored in the same or separates files and loaded and/or executed within elements of glasses 104 either as a single system or as separate processes interacting via any available inter process communication (IPC) techniques. SDDC 160 is described in more detail below in conjunction with FIG. 5.

FIG. 4 is a flowchart of one example of a Secondary Device Data Capture (SDDC) process 299 that may implement aspects of the claimed subject matter. In this example process 200 is associated with logic stored on a non-transitory memory (see 166, FIG. 3) and executed on one or more processors (not shown of glasses 104 (FIG. 1).

Process 200 begins in a “Begin Secondary Device Data Capture (SDDC)” block 202 and processed immediately to a “Capture Data/Image” block 204. Of course it should be understood that a captured image is also merely a form of data but for the sake of clarity the processing of the two types of data are described separately when relevant.

During processing associated with block 204, glasses 104 captures, depending upon the particular configuration either data or an image. In other words, in one configuration, sensor 110 (FIG. 1) of glasses 104 capture an image of whatever is currently displayed on the primary device, which in this example is screen 106 (FIG. 1) and mobile telephone 102 (FIG. 1). Typically, data/image capture is performed under normal lighting to best reflect that which a user is able to see on display 106.

In a second configuration, sensor 110 captures data on the current ambient condition of glasses 104 such as, but not limited to, an intensity level of light and the distance and/or relative motion between glasses 104 and mobile telephone 102. During processing associated with a “Timestamp Data/Image” block 206, a timestamp is added to the data or image captured during processing associated with block 204. This timestamp may be employed later to correlate the data/image captured during processing associated with block 204 with whatever was concurrently displayed on screen 106 (see 136, FIG. 2).

During processing associated with an “Analysis Enabled?” block 208, a determination is made as to whether or not secondary device 104 is configured to analyze the data/image captured during processing associated with block 204. As mentioned above in conjunction with FIG. 3, different configurations of the claimed subject matter may divide the described processing tasks between the primary and secondary devices in different ways. If a determination is made that glasses 104 are not configured to analyze the data/image, control proceeds to a “Transmit Data/image” block 210. During processing associated with block 210, the data/image captured during processing associated with block 210 is transmitted to mobile telephone 102, in this example via wireless link 112 (FIG. 1).

If, during processing associated with block 208, a determination is made that analysis is enabled on glasses 104, control proceeds to an “Analyze Data/image” block 212. During processing associated with block 212, the data/image captured during processing associated with block 204 is analyzed so that glasses 104 can generate parameters, or a “score,” during processing associated with a “Generate Score” block 214. During processing associated with a “Transmit Score” block 216, the score transmitted during processing associated with block 214 is transmitted to mobile telephone 102 via wireless link 112. Finally, once the data/linage has been transmitted during processing associated with block. 210 or the score has been transmitted during processing associated with block 216, control proceeds to an “End SDDC” block 219 during which process 200 is complete.

It should be understood that process 200 would typically be performed a regular intervals, the length of which may be set by assigning a value to a variable (not shown) in operating parameters 178 (FIG. 3). In an alternative embodiment, process 200 may be executed based upon a determination that the user is focusing on display 106. For example, such a determination may be made if particular applications, e.g. video games, are active on mobile telephone 102; if the user is interacting with mobile telephone 102, e.g. the user is actively scrolling pages on display 106: if the user is holding mobile telephone 102 in a particular orientation; and if the user's head is pointed in a certain orientation relative to mobile telephone 102. In addition, the timing of process 200 may be controlled by signals from mobile telephone 102. Those with skill in the relevant arts should appreciate that there may be many ways to optimize the timing of process 200.

FIG. 5 is a flowchart of one example of a Primary Device Display Control (PDDC process 250 that may implement aspects of the claimed subject matter. In this example process 250 is associated with logic stored on a non-transitory memory (see 148, FIG. 2) and executed on one or more processors (not shown) of glasses 104 (FIG. 1).

Process 250 begins in a “Begin Primary Device Display Control (PDDC)” block 252 and processed immediately to a “Receive Image/Score” block 254. During processing associated with block 254, either an image or data in the form of a score, depending upon the configuration of the disclosed technology (see 210, 216, FIG. 4), is received at mobile telephone 102 from glasses 104 (FIG. 1). During processing associated with an “Image Received?” block 256, a determination is made as to whether or not the data received during processing associated with block 254 is an image or a score. If the data is an image, control proceeds to an “Analyze Image” block 258, which corresponds to Analyze Data/image block 212. In other words, the analysis of an image may be performed by either SDDC 160 (FIG. 3) or PDDC 130 (FIG. 2), depending upon the current configuration. In an alternative embodiment, some image processing may be performed by both SDDC 160 and PDDS 130.

Once an image has been analyzed during processing associated with block 258 or if, during processing associated with block 256, a determination is made that the data received during processing associated with block 254 is not an image, control proceeds to a “Correlate to Primary Device (PD) Image” block 260. During processing associated with block 260, the timestamp associated with the data/image received (see 206, FIG. 4) is employed to correlate the data/image with that which was displayed concurrently on display 106 (see 136, FIG. 2). Images on display 106 used for correlation and comparison may be a set of internal snapshots taken at a defined interval and stored on a rolling interval. In the alternative, rather than actual images, analyzed data may be stored and correlated and compared. For example, a pseudo screen shot may be stored that captures parameters associated with that which was likely to on screen 106 at any particular time.

During processing associated with a “Compare image” block 262, the two concurrent images, i.e., the one represented by the image/score received during processing associated with block 254 and the concurrent image on display 106, are compared, or “analyzed,” to determine an appropriate setting for display parameters on mobile telephone 101. Examples of methods of comparison include, but are not limited to, an analysis of the brightness, white balance, intensity, and differences based upon an ROB color model. Differences in parameters based upon different measurement schemes on different devices may need to be normalized, or converted into a common format. Further, depending upon the processing capabilities of different devices, either whole images or portions of images may be analyzed.

During processing associated with a “Generate New Parameters” block 264, the analysis performed during processing associated with block 262 is employed to generate new display parameters for screen 106. For example, the brightness of the primary device, or B_{P}, may be compared to the brightness at the secondary device, or B_{S}, and depending upon which is lighter, the parameters may be adjusted to either brighten or dim screen 106. Parameters that control the size of images or fonts may be changed based upon a calculation of the distance between devices, Of course, any combination of these features, plus others not mentioned but known to those with skill in the relevant arts, may be employed.

During processing associated with an “Implement Parameters” block 266, the parameters generated during processing associated with block 264 are implemented on screen 106 by PDDC 130 of mobile telephone 102. Finally, during processing associated with an “End PDDC” block 269, process 250 is complete.

The terminology used herein is fur the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising;
displaying a first image on a first device, wherein the first image comprises an Image characteristic;
analyzing, at a second device remote from the first device, a viewing. characteristic corresponding to the first image;
responsive to detecting the viewing characteristic meets a criteria, transmitting a signal from the second device to the first device; and
responsive to the signal, controlling a programmable parameter corresponding to the image characteristic on the first device to modify a display of a second image on the first device.

2. The method of claim 1, wherein the criteria is based upon contrast within the first image.

3. The method of claim 1, wherein the programmable parameter is a display brightness on the first device.

4. The method of claim 1, wherein the criteria is based upon a distance between the first device and the second device; and wherein the programmable parameter is a font attribute.

5. The method of claim 1, wherein the criteria is based upon a relative motion between the first device and the second device.

6. The method of claim 1, wherein the viewing characteristic is received for analysis at the second device by a camera on the second device.

7. The method of claim 1, wherein the first device comprises a smartphone and the second device comprises a pair of glasses.

8. A apparatus, comprising;
a display;
a first sensor;
a non-transitory computer-readable medium,
a first plurality of processors; and
logic, stored on the computer-readable medium and executed on the plurality of processors, for:
displaying a first image on the display, wherein the first image comprises an image characteristic;
receiving, from a secondary device, data generated by the secondary device, wherein the data corresponds to the first image as captured by a sensor on the secondary device;
generating a display parameter based upon the data and the first image characteristic; and
in response to the generating, adjusting the display in accordance with the display parameter.

9. The apparatus of claim 8, wherein the image characteristic is based upon. contrast within the first image.

10. The apparatus of claim 8, wherein the display parameter corresponds to a brightness level of the display.

11. The apparatus of claim 8, the lode further comprising logic for calculating, based upon the data, a distance between the apparatus and the secondary device and wherein the display parameter is a font attribute.

12. The apparatus of claim 1, wherein the data is the first image as captured at the secondary device.

13. The apparatus of claim 8, wherein the data is the image characteristic as captured at the secondary device.

14. The apparatus of claim 8, wherein the apparatus comprises a smartphone.

15. A apparatus, comprising:
a sensor;
a non-transitory computer-readable medium,
a first plurality of processors; and
logic, stored on the computer-readable medium and executed on the plurality of processors, for:
capturing a first image on a display of a primary device that is a different device than the apparatus, wherein the first image comprises an image characteristic;
generating data corresponding to the first image;
transmitting the data from the apparatus to the primary device such that the primary device generates a display parameter based upon the data and the first image characteristic; and, in response to the generating of the display parameter, adjusts the display in accordance with the display parameter.

16. The apparatus of claim 15, wherein the image characteristic is based upon contrast within the first image.

7. The apparatus of claim 15, wherein the display parameter corresponds to a brightness level of the display.

18. The apparatus of claim 15, wherein the primary device calculates, based upon the data, a distance between the apparatus and the primary device and wherein the display parameter is a font attribute.

19. The apparatus of claim 1, wherein the data is the first image as captured by the sensor at the apparatus.

20. The apparatus of claim 8, wherein the data is the image characteristic as captured at the apparatus.
